(19) United States
(12) Patent Application Publication
(10) Pub. No.: US 2004/0002947 A1
(43) Pub. Date: Jan. 1, 2004

(54) Favorites for internet-access appliances

(76) Inventors: Ramon De La Fuente, Cupertino, CA (US); Sven De Bie, Cupertino, CA (US); Daniel Meirsman, Sunnyvale, CA (US); Arjan van Ham, San Jose, CA (US); Daniel Graf, San Francisco, CA (US); Jean-Marc Matteini, Saratoga, CA (US)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/317,895

(22) Filed: Dec. 12, 2002

Related U.S. Application Data
(60) Provisional application No. 60/392,378, filed on Jun. 26, 2002.

(51) Int. Cl. G06F 7/00

(52) U.S. Cl. 707/1

(57) ABSTRACT

A method and system facilitates the creation and maintenance of favorites lists (165) on the Internet (140). Devices (110) that have access to the Internet (140) have direct access to each of a user's favorites lists (165), and can be configured to facilitate modifying the favorites lists (165). Devices (110) that lack direct access to the Internet (140) are configured to receive ‘downloaded’ copies of lists (165) that are maintained on the Internet (140), and optionally to provide ‘uploadable’ copies of modified lists for updating the favorites lists (165).

This invention claims the benefit of U.S. Provisional Application No. 60/392,378, filed Jun. 26, 2002.

### TECHNICAL FIELD

This invention relates to the field of consumer electronics, and in particular to a method and system for storing and retrieving user-defined favorite selections of audio, video, photo, animation, gaming, and other content material.

### BACKGROUND ART

The availability of large volumes of content material has given rise to the popularity of systems that allow a user to define ‘favorites’, to facilitate the rendering of preferred selections from among a plurality of available selections.

Conventionally, a user programs a playback device to remember which selections are preferred. Typically, for example, while an audio piece is being rendered, the user has the option to press an “add to favorites” button to have the piece added to a list of favorites. The user is also provided the option of selecting a “delete from favorites” button to modify the list of favorites. If the device includes a more sophisticated user interface, the user may be provided the option of identifying pieces to add to a favorites list even if the piece is not currently being rendered. Some systems allow a user to identify multiple favorites lists, such as a favorite romance list, a favorite dining list, a favorite rock list, and so on. In the video field, a user may identify favorite dramas, favorite sit-coms, and so on; in the photo field, a user may identify favorite landscapes, favorite portraits, family favorites, and so on.

In addition to an explicit identification of favorite pieces, some systems are configured to allow the user to identify ‘preferences’, from which the system automatically or semi-automatically identifies favorite selections that correspond to the user's identified preferences. Alternatively, or additionally, a system may be configured to monitor the user's prior selections, to generate a favorites list that includes frequently selected material, or material that is similar to previously selected material. A favorites list may also be configured to include classes of selections, in addition to or in lieu of a list of individual selections. For example, the user may identify all work of a certain artist as a favorite, or all work in a particular genre by a given artist or group of artists as a favorite.

Similarly, a broadcast-receiving device, such as a conventional radio tuner, typically allows a user to identify favorite channels. An automobile radio, for example, allows the user to preset a certain number of channels to buttons on the radio, for rapid tuning to a select favorite channel. Home entertainment systems typically allow a user to program favorite audio channels as well. Television tuners also commonly provide for an identification of channel favorites, to facilitate rapid selection among the hundreds of channels that may be available for selection.

Conventionally, a user must ‘program’ each device to record the user's favorites. If the user has two automobiles, the preset channels for the radio in each vehicle must be programmed by the user; if the automobiles include CD players, each CD player must be programmed to record the user's favorites. These program activities are in addition to the identification of favorite selections or channels on the user's home-entertainment system, the identification of favorites on the user's personal computer(s), the identification of favorites in an MP3-player downloading application, and so on.

### DISCLOSURE OF INVENTION

It is an object of this invention to facilitate the creation of one or more user-defined favorites lists. It is a further object of this invention to facilitate access to the one or more favorites lists by multiple devices. It is a further object of this invention to facilitate an integration of tasks related to creating or maintaining favorites lists.

These objects and others are achieved by providing a method and system that facilitates the creation and maintenance of favorites lists on the Internet. Devices that have access to the Internet have direct access to each of a user's favorites lists, and can be configured to facilitate modifying the favorites lists. Devices that lack direct access to the Internet are configured to receive ‘downloaded’ copies of lists that are maintained on the Internet, and optionally to provide ‘uploadable’ copies of modified lists for updating the favorites lists.

### BRIEF DESCRIPTION OF DRAWINGS

The invention is explained in further detail, and by way of example, with reference to the accompanying drawings wherein:

FIG. 1 illustrates an example block diagram of a favorites system in accordance with this invention.

FIG. 2 illustrates an example block diagram of a rendering device with Internet-access in accordance with this invention.

Throughout the drawings, the same reference numerals indicate similar or corresponding features or functions.

### BEST MODE OF CARRYING OUT THE INVENTION

Increasingly, consumer products are becoming “Internet-enabled”, either directly via wired or wireless telecommunications paths, or indirectly via access a local-area-network (LAN) to a device that is connected to the Internet. Alternatively, less sophisticated products are configured to remotely receive information from the Internet by a sequence of ‘download’ operations, such as a download of material from the Internet to a PC, then a download of the material, or processed material, from the PC to the particular product, such as an MP3-player, a memory-stick, or a gaming device. For ease of reference, products or devices that are configured to be able to receive information from the Internet are termed herein as appliances that have Internet-access, regardless of whether the access to the information is direct, indirect, remote, and so on. Depending upon the particular device, the access may be unidirectional (receive-only) or bidirectional (transmit and receive).

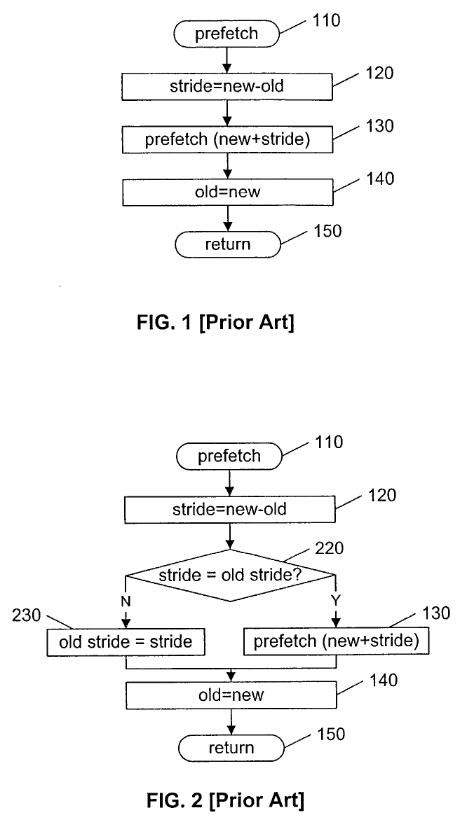

FIG. 1 illustrates an example block diagram of a system 100 that facilitates the creation and maintenance of one or more favorites lists 165 for access via appliances 110 that have Internet-access in accordance with this invention. Generally, the relevant appliances 110 of this invention are devices that are configured to render or otherwise process content material, such as audio, video, animation, and other recorded material.

Each appliance 110 has access to a plurality of content material 115, and the lists 165 are provided to facilitate selection of particular selections from among the plurality of material 115. The selection based on a list 165 may be exclusive, such that only material that is included in the list 165 is selected, or inclusive, such that material that is included in the list 165 is preferentially selected and included with material that is not necessarily included in the list 165.

In accordance with this invention, to facilitate the creation of a favorites list that can be accessed by multiple appliances 110 of a user, the favorites list 165 is stored at a server 150 that is accessible via the Internet 140. As detailed below, the server 150 includes a storage 160 that is configured to contain multiple lists 165. A user is provided the option to create one or more lists 165 that are stored at the storage 160 that is accessed via the via the server 150, typically via access to an Internet web-site corresponding to an application running on the server 150. The selection of content material to be added to the list is conveniently effected by identifying the content material as a favorite while the content material is being rendered at the appliance 110. Alternatively, other methods of selecting, and deselecting, material to be added to the list may be used, such as the conventional schemes discussed above.

After a favorites list 165 is created and stored at a web-site or server 150 that is accessible via the Internet 140, the user can access the list 165 via any of the user's appliances 110, including mobile appliances, such as mobile phones, personal data assistants (PDAs), and so on. As contrast to conventional systems, because the list 165 of this invention is stored at a server 150, any appliance that has Internet-access can access the list 165, and the user need not re-create a favorites list 165 for each appliance 110. The favorites lists 165 of a user may include a specific identification of particular selections of content material, a general identification of types or classes of content material, an identification of particular sources of content material, such as favorite radio or television stations, favorite games, certain levels of select games, and so on. The sources of content material may include an identification of the broadcast frequency of a radio station, a channel of a television station, or a URL of a source 120 of content material 125 that is accessible via the Internet 140. As in conventional systems, a user may create different lists 165 for different situations, different environments, different moods, different types of content material, different gaming skill levels, and so on. For example, a user may segregate a game list into relaxation games, challenge games, group games, and so on.

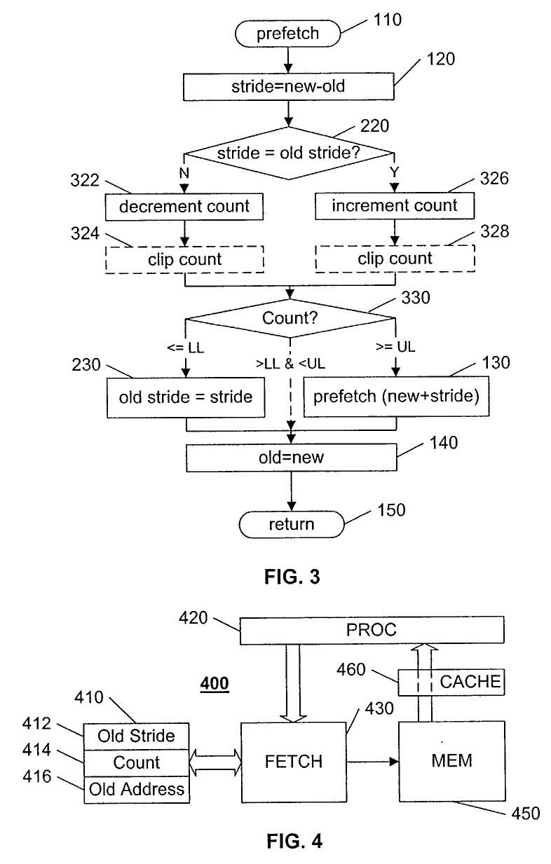

FIG. 2 illustrates an example block diagram of a rendering device 110 that is configured to facilitate selection of content material 230 based on a favorites list that is accessed via the Internet. An Internet-access component 210 within the device 110 is configured to upload or download a copy of a favorites list 220 to and from a storage (160 at FIG. 1) at a server (150) via the Internet (140). Preferably, the list 220 is stored, at least temporarily, at the rendering device 110, to facilitate access to the list 220 when the device 110 is not connected to the Internet, and to optionally facilitate a subsequent download, via a downloader 260, of the list 220 to another device that does not communicate via the Internet, such as a portable MP3 player.

A selector 240 uses the list 220 to facilitate selection from among a plurality of content material 230 for presentation to a renderer 250 that renders the selected content material. Additionally, the selector 240 is preferably configured to include an “add to favorites” and “delete from favorites” button that allows a user to modify the list 220. At the user's option, the list 220 can be uploaded to the storage (160 in FIG. 1) at the server (150) on the Internet (140) for subsequent access by this or other rendering devices 110.

Note that with the increased availability of appliances with web-access, such appliances are likely to appear in a variety of venues. For example, rental-cars, airplanes, hotels, and so on, can be expected to include Internet-access appliances. In the context of this invention, a user could access a favorites list on the Internet from any of these venues to facilitate the selection of content material. A business traveler, for example, could identify favored radio stations in a visited city. Upon return to that city, the traveler merely provides a user identification, and the radio in the traveler's rental-car is preset with the traveler's favorites. Similarly, the television in the traveler's hotel room could be preset to the traveler's favored networks, and the audio on the airplane is configured to provide selections consistent with the traveler's preferences.

This invention also provides a commercial opportunity for providing the web-site and/or server 150 and companion facilities for creating and maintaining favorites lists 165. In accordance with this aspect of the invention, a web-site provider provides a plurality of users with the ability to create, modify, and download favorites lists 165. Each user is provided a user identification and a password, and access to each list 165 is restricted based on the user identification and password.

The web-site provider may charge each user a fee for this service, or may provide the service as a ‘courtesy’, to present a forum for presenting advertisements to the user, or for collecting information regarding a user's preferences, and so on. In a preferred embodiment of this invention, the web-site or server 150 is provided by a vendor of a rendering device 110 that is configured to facilitate the creation and maintenance of lists 165 on the Internet 140, and is provided as a courtesy to all purchasers of the device 110. In this manner, the web-site or server 150 provides an opportunity for “product-distinction” among vendors of devices 110, and providing the web-site or server 150 can be expected to encourage sales of the particular vendor's device 110.

In the context of travel, car-rental agencies, hotels, and airlines could provide a web-site or server 150 to facilitate entertainment selections for a traveler. Again, providing the web-site or server 150 for storing a user's favorites can be expected to provide an encouragement for the user to use/purchase the services offered by the provider of the website, or by sponsors/advertisers of the web-site.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

1. A method of facilitating access to a favorites list, including:
facilitating creation of the favorites list,
facilitating storage of the favorites list at an Internet-accessible server, and
facilitating subsequent access to the favorites list at the Internet-accessible server via a first device, thereby facilitating selection of content material on the first device based on the favorites list.

2. The method of claim 1, further including
facilitating subsequent access to the favorites list at the Internet-accessible server via a second device, thereby facilitating selection of content material on the second device based on the favorites list.

3. The method of claim 1, further including
facilitating storage of the favorites list at the first device, thereby facilitating selection of content material on the first device when the first device does not have access to the Internet-accessible server.

4. The method of claim 1, wherein
the favorites list includes at least one of:
a list of favorite selections from one or more storage discs,
a list of favorite channels for receiving content material,
a list of favorite games,
a list of favorite recordings in a memory, and
a list of user-defined preferences.

5. The method of claim 1, further including
facilitating a download of the favorites list for subsequent loading to an other device, to facilitate selection of content material on the other device based on the favorites list.

6. The method of claim 1, wherein
the favorites list includes identification of at least one of:
audio content material,
video content material, and
image content material.

7. A rendering system, comprising:
a renderer that is configured to render select content material,
an Internet-access device that is configured to access a favorites list that is stored at an Internet-accessible server, and
a selector that facilitates selection of the select audio content based on the favorites list.

8. The rendering system of claim 7, wherein
the Internet-access device is also configured to facilitate access to one or more sources of content material, and
the selector is further configured to facilitate selection of a select source of the one or more sources based on the favorites list.

9. The rendering system of claim 7, wherein
the selector is further configured to facilitate modification of the favorites list.

10. The rendering system of claim 7, further including
a downloader that is configured to subsequently download the favorites list to an other rendering system.

11. The rendering system of claim 7, further including
a memory that is configured to store the favorites list.

12. The rendering system of claim 7, wherein
the favorites list includes at least one of:
a list of favorite selections from one or more storage discs,
a list of favorite channels for receiving content material,
a list of favorite games,
a list of favorite recordings in a memory, and
a list of user-defined preferences.

13. The rendering system of claim 7, wherein
the favorites list includes identification of at least one of:
audio content material,
video content material, and
image content material.

14. The rendering system of claim 7, wherein
the renderer includes at least one of:
an audio playback system,
a video playback system,
a gaming system, and
an information processing system.

15. A method of facilitating creation and maintenance of a favorites list, including:
providing an Internet server that facilitates
creation of the favorites list,
modification of the favorites list, and
downloading of the favorites list.

16. The method of claim 15, further including
providing access to the Internet server based on a purchase of an Internet-access device, thereby encouraging the purchase of the Internet-access device.

17. The method of claim 16, wherein
the favorites list includes a list of content material, and
the Internet-access device includes a rendering device for rendering the content material.

18. The method of claim 15, further including
providing access to the Internet server based on a purchase of a product sponsored by a provider of the Internet server, thereby encouraging the purchase of the product.

19. The method of claim 15, wherein
the favorites list includes at least one of:
a list of favorite selections from one or more storage discs,
a list of favorite channels for receiving content material,
a list of favorite games,
a list of favorite recordings in a memory, and
a list of user-defined preferences.

20. The method of claim 15, wherein
the favorites list includes identification of at least one of:
audio content material,
video content material, and
image content material.
